(19) United States
(12) Patent Application Publication
(10) Pub. No.: US 2003/0169369 A1
(43) Pub. Date: Sep. 11, 2003

(54) Consumer video captioning system

(76) Inventor: Michael Kahn, Westampton, NJ (US)

Correspondence Address: RATNERPRESTIA, P O BOX 980, VALLEY FORGE, PA, 19482-0980, US

(21) Appl. No.: 10/091,098

(22) Filed: Mar. 5, 2002

(51) Int. Cl. H04N 7/16; H04N 7/00; H04N 11/00; H04N 5/445

(52) U.S. Cl. 348/468; 348/563; 725/151

(57) ABSTRACT

A set top box for use with a video signal captioning system is provided. The set top box includes a first port for receiving caption text. The set top box also includes a second port for receiving a video signal. The set top box converts the caption text from the computer into a video image. The set top box then combines the video signal from the video source with the video image. The combined signal from the set top box is transmitted as an output video signal.

### FIELD OF THE INVENTION

The present invention relates generally to consumer electronic video devices, and more particularly, to a consumer video captioning system.

### BACKGROUND OF THE INVENTION

In the creation and editing of home movies, it is often desirable to include a caption message on the video display. For example, when a video is displayed on a television or computer monitor, it may be desirable to display caption text to identify certain scenes of the video.

Many television receivers include a closed-caption decoder that is used to display closed-caption text. For example, closed-caption data may be combined with a broadcast signal from a broadcasting station. The closed-caption data combined with the broadcast signal may then be decoded and displayed using the closed-caption decoder in the television. The use of caption text in this context is limited because only the closed-caption data included with the broadcast signal may be displayed.

Another method of including caption text in a video signal is to use a video cassette recorder or camcorder that includes a caption signal generation circuit. For example, a camcorder may include a character generation circuit and some type of textual input device (e.g., a keypad on the camcorder). An example of such a system is U.S. Pat. No. 5,502,487 to Choi, that discloses a camcorder including a character signal generator 70.

One drawback of the systems including a character generation circuit and an input device is that only a limited amount of caption text can be added. For example, the memory included in the camcorder may only provide for a small amount of caption text to be stored. Further, the editing and customization features of the character input and generation system may be very limited. For example, only a standard font size, font color, and font style may be available.

### SUMMARY OF THE INVENTION

An exemplary embodiment of the present invention provides a set top box for use in a video signal captioning system. The set top box includes a first port for receiving caption text, for example from a text file in a personal computer. The set top box also includes a second port for receiving a video signal, for example, from a video source such as a camcorder or a video cassette recorder. The set top box converts the caption text from the computer into a video image. The set top box then combines the video signal from the video source with the video image. The combined signal from the set top box is transmitted as an output video signal.

In another exemplary embodiment of the present invention a set top box for use in a video signal captioning system is provided. The set top box includes a first port for receiving caption text and a second port for receiving a video signal. The set top box also includes a closed caption encoder for encoding the video signal with the caption text to form an output video signal.

In another exemplary embodiment of the present invention, a method of combining caption text with a video signal is disclosed. Caption text, from a computer for example, is received in a set top box. A video signal from a video source is also received in the set top box. The caption text from the computer is converted into a video image in the set top box. The video signal and the video image are then combined into an output video signal.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following Figures:

FIG. 1 is a block diagram illustrating a video signal captioning a system in accordance with an exemplary embodiment of the present invention.

FIG. 2 is a block diagram illustrating a video signal captioning system in accordance with another exemplary embodiment of the present invention.

FIG. 3 is a block diagram illustrating a video signal captioning system including a set top box suitable for use with the embodiment illustrated in FIG. 2.

FIG. 3a is a flow chart illustrating operation of a computer in accordance with an exemplary embodiment of the present invention.

FIG. 3b is a flow chart illustrating operation of a set top box in accordance with an exemplary embodiment of the present invention.

FIG. 4 is a block diagram illustrating a video signal captioning system in accordance with yet another exemplary embodiment of the present invention.

FIG. 5 is a flow chart illustrating a method of combining caption text and a video signal in accordance with an exemplary embodiment of the present invention.

FIG. 6 is a flow chart illustrating a method of combining caption text and a video signal in accordance with another exemplary embodiment of the present invention.

FIG. 7 is a block diagram illustrating caption text and video display images in accordance with an exemplary embodiment of the present invention.

FIG. 8 is a block diagram illustrating caption text and video display images in accordance with an exemplary embodiment of the present invention.

### DETAILED DESCRIPTION OF THE INVENTION

In an exemplary embodiment of the present invention, the user has written some lines of text (e.g., a priori) on the user's computer. The user then plays a video (e.g. a home movie) using a video source. As the user watches the play back of the video the user would like to output lines of the text stored in the computer to appear as caption text on certain scenes of the video. In the exemplary embodiment, a key is designated on the computer keyboard to transmit a line of text from the computer file to the set top box for conversion into a video image, and ultimately to be combined with another video signal from the video source. In a further preferred embodiment, each time the user presses the designated key on the computer keyboard, the next line of text in the text file is transmitted to the set top box for combination with the video signal from the video source.

Pressing the designated key sends the ASCII characters of the respective line of text from the computer to the main microprocessor of the set top box via the serial port. The main microprocessor then sends the text information, in the proper graphical format, to a video decoder and display processor that is included in the set top box. The video decoder and display processor outputs the analog video signal (the video signal with the user's text overlaid) to a video recording device. The video recording device (e.g., a mixdown VCR) records the combined video signal on a video storage medium.

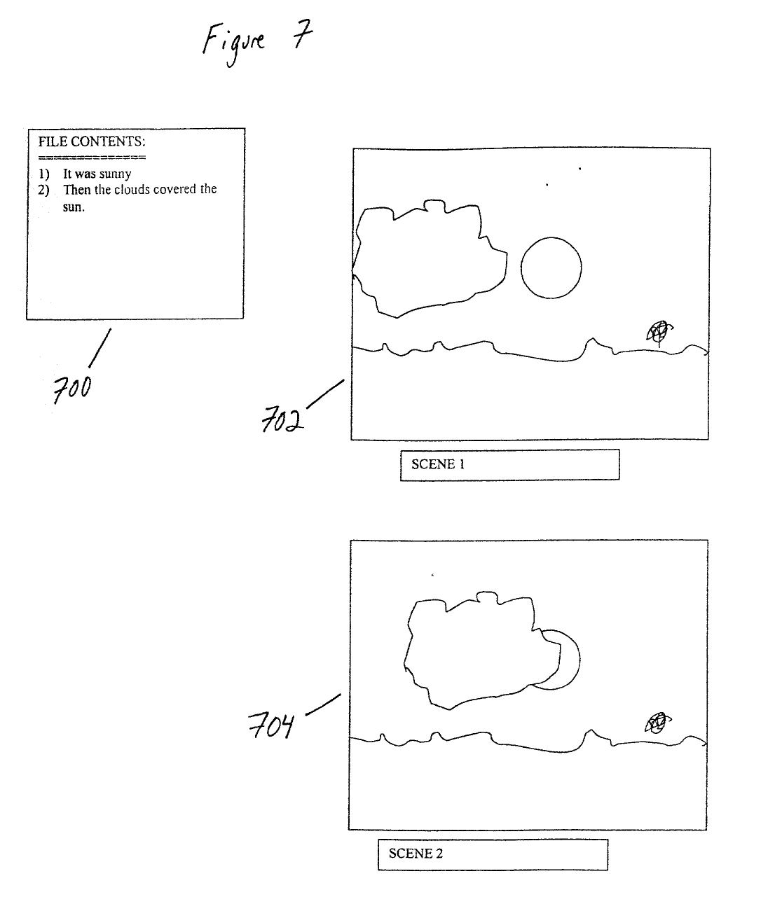

FIG. 7 illustrates the contents of a computer text file and video scenes in accordance with an exemplary embodiment of the present invention. File contents 700 includes two lines of text. File contents 700 is a file stored in a computer. A first line of text in file contents 700 reads “It was sunny.” A second line of text in file contents 700 reads “Then the clouds covered the sun.” For example, a user may wish to enter each of these text lines from file contents 700 into a corresponding scene of a home video. Of course, file contents 700 could include more or less than two lines of text.

Scene 702 illustrates a first scene in a home video to which a user wishes to add a line of caption text. Scene 704 illustrates a second scene in a home video to which a user wishes to add another corresponding line of caption text.

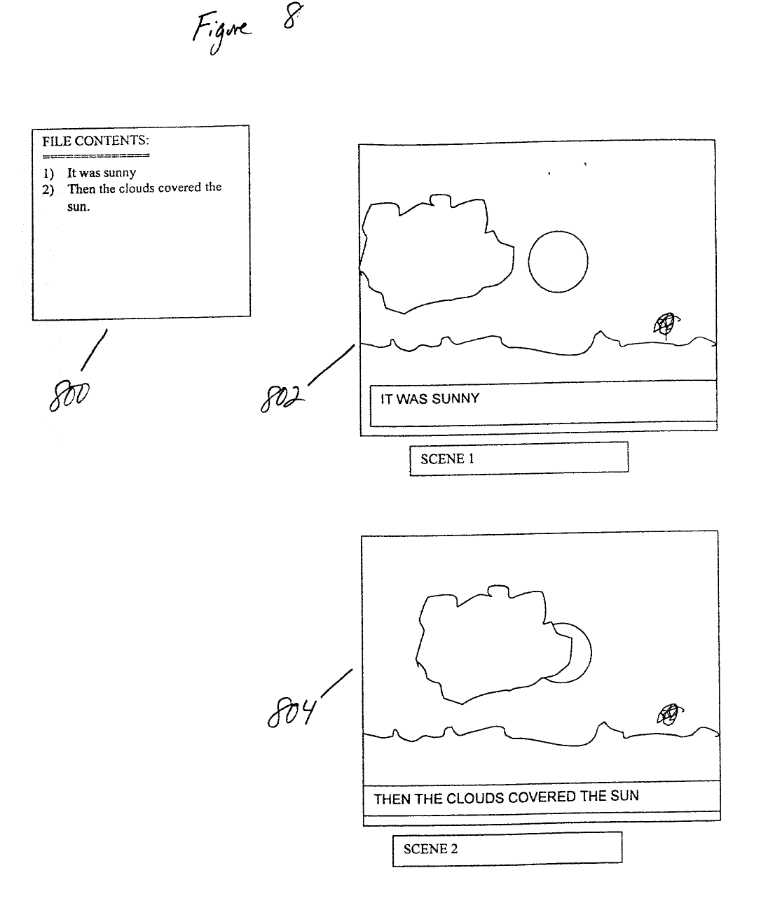

With the video captioning system in operation, the user plays a video signal, for example, a home movie. When scene 702 is displayed, the user strikes the designated key on the computer keyboard and outputs the first line of text from file contents 700 to the set top box through the serial port. The first line of caption text from file contents 700 is converted into a video image and is combined with the video signal (scene 702) in the set top box. The output video signal (the combination of the video image and the video signal) is transmitted through an output port of the set top box to a video recording device. The video recording device records the output video signal onto a video storage medium. The resulting video signal on the video storage medium is shown as scene 802 in FIG. 8. As shown in FIG. 8, scene 802 includes the video signal from scene 702 along with a corresponding line of caption text.

As the home movie continues to be displayed, scene 704 is displayed. At this time the user again presses the designated key on the computer and sends the second line of caption text from file contents 700 to the set top box through a serial port. The second line of caption text is converted into a video image, and is combined with the video signal (scene 704). The combined signal forms the output video signal which is transmitted to a video recording device to be recorded onto a video storage medium. The signal recorded on the video storage medium is shown in FIG. 8 as scene 804. Scene 804 illustrates the output video signal which represents the combined video signal (scene 704) and the second line of caption text.

In an alternative embodiment of the present invention the user may select the placement location of the text on the screen. For example, the user may desire to include the caption text at the top, bottom, left, or right hand portions of the screen.

The type of computer and the type of operating system utilized in the present invention is not important. Any computer and operating system that can support text files and serial communications will satisfy the needs of the present invention. For example, the computer system may be a Windows, Macintosh, or Linux based computer system. Further, a hand held computing device, such as a personal digital assistant (PDA), could be used since they support text files and serial communications.

The set top box utilized in the present invention is preferably a digital television set top box. In the embodiment described herein, many of the internal components of the set top box are not shown. Only the relevant components, and the relevant connections are shown.

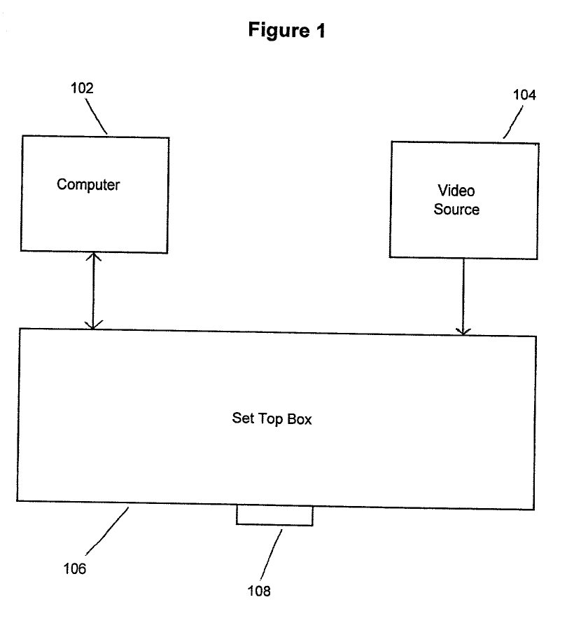

FIG. 1 illustrates an exemplary embodiment of the present invention. The video signal captioning system illustrated in FIG. 1 includes a computer 102, a video source 104, and a set top box 106. The set top box 106 includes an output port 108. The video source 104 may be a video cassette recorder (VCR), a camcorder, or any other video source. The camcorder may be, for example, an 8 millimeter, VHSC, or VHS camcorder. Video source 104 supplies a video signal to set top box 106. Computer 102 stores caption text in its memory. The computer may include any type of operating system so long as it can support text files, and data communications. Caption text is transmitted from computer 102 to set top box 106. Set top box 106 converts the caption text transmitted from computer 102 into a video image. Set top box 106 then combines the video signal from video source 104 with the video image. The combined output video signal may be transmitted through port 108.

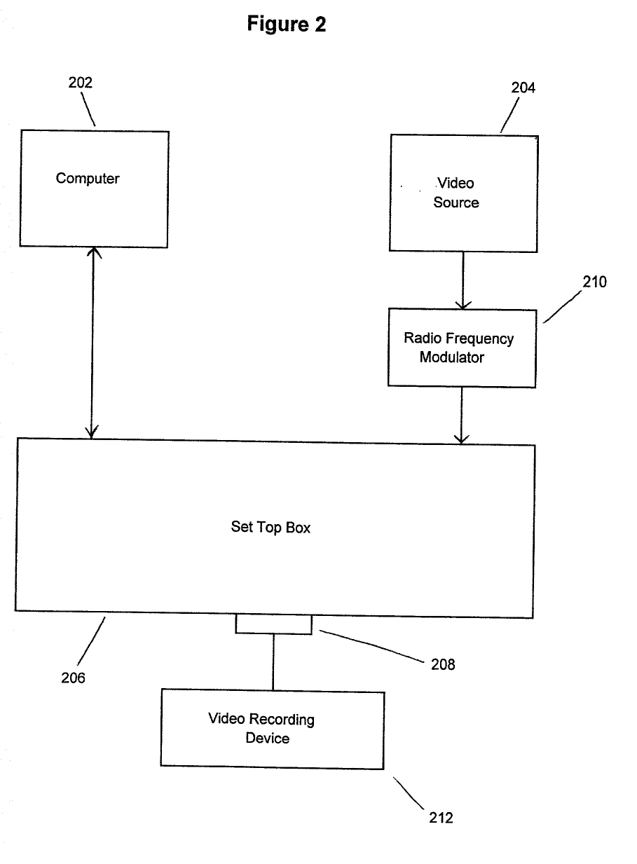

FIG. 2 illustrates another exemplary embodiment of the present invention. Video source 204 supplies a video signal to radio frequency modulator 210. Radio frequency modulator 210 may be a dedicated radio frequency modulator, or alternatively could be a radio frequency modulator included in a video device such as a VCR. The video signal is modulated in radio frequency modulator 210 and is then transmitted to set top box 206. Set top box 206 includes a demodulator (not shown) for demodulating the signal from radio frequency modulator 210, thereby converting the signal to a baseband analog signal.

Computer 202 includes caption text stored in its memory. The caption text is transmitted from computer 202 to set top box 206.

Set top box 206 converts the caption text from computer 202 into a video image. Set top box 206 then combines the video signal (the signal transmitted from radio frequency modulator 210) with the caption video image. The combined signal is then provided as an output video signal through port 208. This signal may be, for example, a component video signal, a baseband signal or a modulated radio frequency signal

The output video signal transmitted through port 208 is received by video recording device 212. For example, video recording device 212 may be a mixdown VCR, or any other device for recording video onto a video storage medium. As such, video recording device 212 may be an analog or digital VCR, a recordable DVD writer, a personal video recorder, etc.

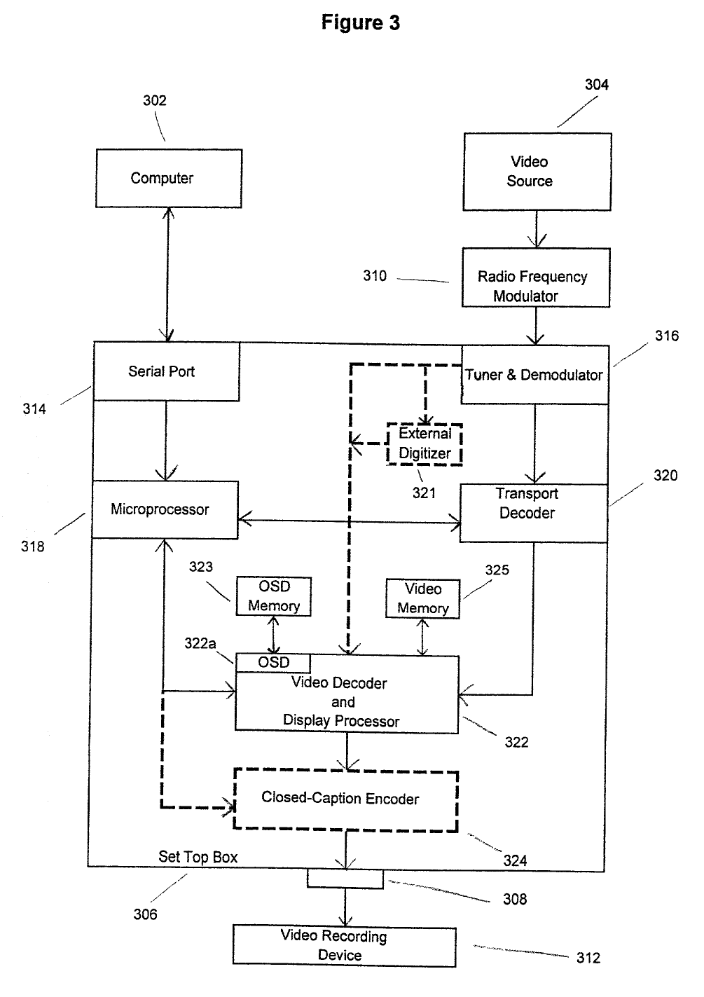

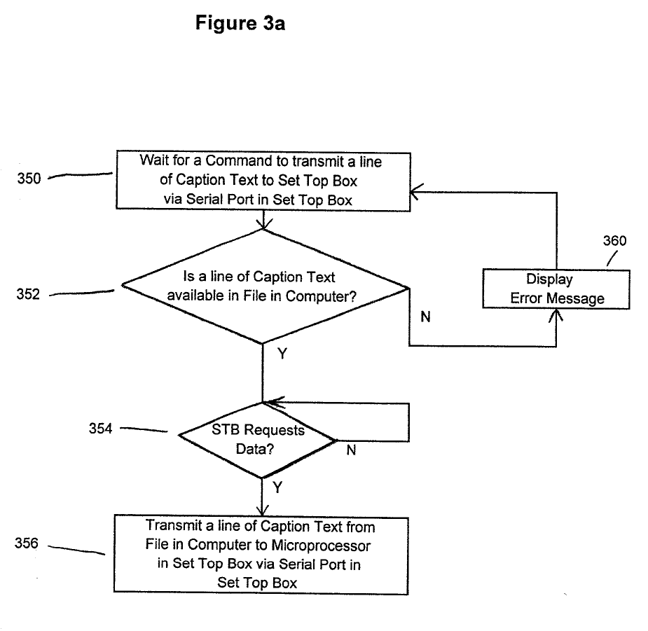

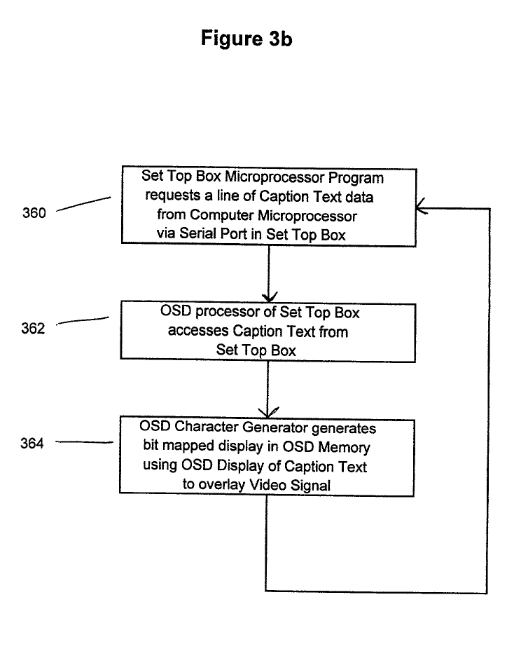

FIG. 3 illustrates an exemplary video signal captioning system that includes a set top box suitable for use with the embodiment illustrated in FIG. 2. Video source 304 transmits a video signal to radio frequency modulator 310. Radio frequency modulator 310 modulates the video signal from video source 304, and transmits the modulated video signal to the tuner and demodulator 316 included in set top box 306. For example, tuner and demodulator 316 may be an NTSC tuner. Tuner and demodulator 316 converts the radio frequency input signal from radio frequency modulator 310 into a baseband analog signal. Alternatively, tuner and demodulator 316 could recover an ATSC or QAM encoded bit stream.

Computer 302 stores caption text in its memory. Computer 302 transmits the caption text to serial port 314 included in set top box 306. For example, serial port 314 may be a low speed port (e.g., RS-232) with an external connection, or may alternatively be a USB connection, or a faster connection with a greater bandwidth such as an IEEE 1394 FireWire connection. Therefore, any type of data connection between the computer 302 and the set top box 306 is satisfactory for the transmission of the caption text.

The baseband analog signal is provided by tuner and demodulator 316 to the transport decoder 320. For example, transport decoder 320 may be an ATSC decoder. Transport decoder 320 may receive the ATSC transport stream packets and extract the bit stream from the packets. The decoded signal is then transmitted from transport decoder 320 to the video decoder and display processor 322 for additional decoding and processing of the ATSC signal. For example, the bit stream may be decoded at the video decoder and display processor 322.

Video decoder and display processor 322 can receive a digital input from transport decoder 320, and overlay graphics and text onto the video signal, which may comprise an on-screen display (OSD).

Specifically, video decoder and display processor 322 includes an OSD (on-screen display) processor 322a. After a line of caption text is received in the set top box through the serial port 314, the microprocessor 318 provides the line of caption text to the OSD processor 322a. The OSD processor 322a stores the line of caption text in the OSD memory 323.

The exemplary video decoder and display processor 322 receives an ATSC bit stream from transport decoder 320. The bit stream is decoded and he resultant video images are stored in the video memory 325.

The video and display processor then overlays the line of caption text stored in the OSD memory 323 (in the form of a video image) on the video signal stored in the video memory 325, thereby forming a captioned output video signal.

Alternatively, the video signal received by tuner and demodulator 316 may be a NTSC signal that does not require decoding at transport decoder 320, in contrast to the ATSC signal described above. As such, the video signal is transmitted from tuner and demodulator 316 directly to video decoder and display processor 322, as indicated by the dashed line in FIG. 3. In this instance, the processor 322 may only digitize and process the video signal provided by the tuner and demodulator 316. Alternatively, an external digitizer 321 could be included, providing the processor 322 with a digitized input to be mixed with the caption image.

Microprocessor 318 controls the devices in the set top box 306, for example, the transport decoder 320, and the video decoder and display processor 322.

An output video signal, which includes both the video signal and the caption text(from the video memory 325 and the OSD memory 323, respectively), is transmitted from video decoder and display processor 322 to the video recording device 312 through port 308. Video recording device 312 records the output video signal onto the video storage medium.

Although a single output port 308 is shown in FIG. 3, numerous output ports may be included in the set top box 306. For example, a distinct output port may be provided for each of a component video signal, an RGB video signal, a S-video signal, a composite video signal, and a modulated composite video signal. If an RGB output port is included, and a closed-caption signal is to be transmitted from the set top box 306 to the video recording device 312, the closed-caption signal may be included on each component of the RGB video signal, or solely on the green component of the RGB video signal.

As described above, the video decoder and display processor 322 may include an on-screen display (OSD) processor to access the caption text from the microprocessor 318 and to generate a bit mapped display to overlay the video signal. In an alternative embodiment, the set top box 306 may include a closed-caption encoder 324 for encoding the video signal with caption text before transmitting the closed-caption encoded signal to the video recording device 312.

FIG. 3a is a flow chart that illustrates the operation of the computer 302 in connection with an exemplary embodiment of the invention. The computer 302 includes a program stored in memory that runs during operation of the captioning system. The program first waits for a command to transmit a line of caption text to the set top box 306 at step 350. The command, for example, could be a pre-defined keystroke on the keyboard of the computer 302. After receiving the command the program then determines if a line of caption text is available for transmission in a file stored in the memory of the computer at step 352.

If a line of caption text is available, the computer then determines if the set top box is requesting the caption text data at step 354. If the set top box 306 is requesting the caption text data then the computer transmits the line of caption text from the file in the computer 302 to the microprocessor 318 in the set top box 306 via serial port 314 in set top box 306. If the set top box 306 is not requesting caption text data at step 354, then the computer continues to determine whether the set top box 306 is requesting caption text data in the loop shown at step 354.

If the computer determines that no line of caption text is available at step 352, then the computer transmits an error message at step 360, for example, to be displayed on a monitor connected to the computer 302. The program then returns to step 350 to wait for another command to transmit a line of caption text.

FIG. 3b is a flow chart that illustrates the operation of a program running on the microprocessor 318 of the set top box 306 in connection with an exemplary embodiment of the invention. The program requests that a line of caption text be transmitted from the computer 302 to the set top box 306 via the serial port 314 in the set top box 306, at step 360. After the line of caption text has been received, the microprocessor 318 provides the line of text to the OSD processor in the video display processor. At step 364, the OSD character generator generates a bit mapped display of the line of caption text and stores the generated display in the OSD memory 323. When the video image is read out of the OSD memory, the OSD image is used to generate an overlay image to overlay onto the display of the video signal provided by transport decoder 320 The output video signal, including the overlay display, may then be transmitted to a video recording device 312 for recording on a video storage medium. Although not explicitly illustrated, it is understood that the output video signal may have been converted into an encoded video signal using an encoder before transmission to the video recording device 312. The program then returns to step 360 and requests another line of caption text from the microprocessor of computer 302.

In the embodiment described by reference to FIG. 3b, an OSD processor is included in the video decoder and display processor 322 to generate a bit mapped display to overlay the video signal, however, an OSD processor is not required. For example, a closed-caption encoder 324 could alternatively be included (as shown in FIG. 3) to provide a closed-caption encoded output signal. The user can then optionally select to view the video signal with or without the caption text, using the closed-caption decoder in the television receiver. The closed-caption encoder is desirably only used for video signals that do not already include closed-caption information. Alternatively, the closed-caption encoder could be used to replace any closed-caption information already included in the video signal.

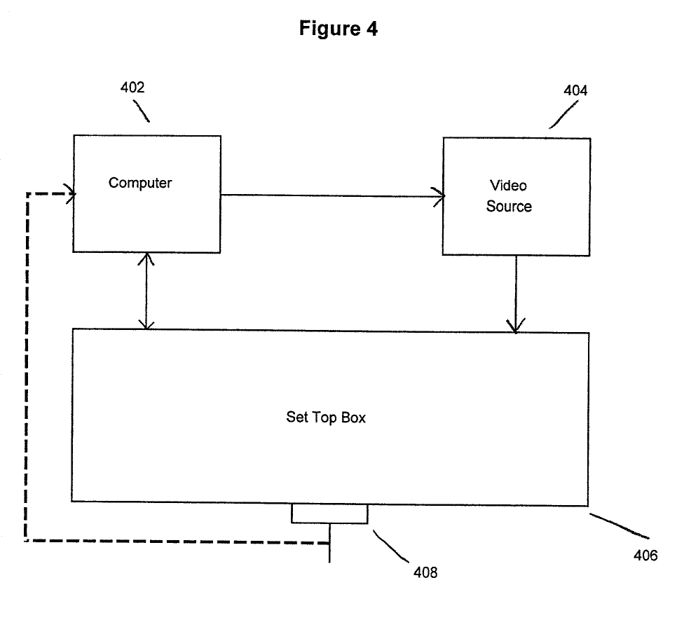

FIG. 4 illustrates another exemplary embodiment of the present invention. Computer 402 includes caption text stored in its memory. The caption text is transmitted from computer 402 to set top box 406. Computer 402 may optionally control video source 404. For example, computer 402 may initiate the video signal being transmitted from video source 404 to set top box 406. Therefore, upon receiving a command from computer 402, video source 404 transmits a video signal to set top box 406. This configuration, where the computer 402 controls the operation of video source 404, simplifies the video captioning process in that all of the control of the system initiates with the computer 402. In controlling the video captioning process, the computer may include a television card.

The caption text transmitted from computer 402 to set top box 406 is converted in set top box 406 into a video image. The video signal and the video image are then combined in set top box 406. The combined signal is the output video signal of the set top box 406 and may be transmitted through port 408.

Additionally, the output video signal transmitted from set top box 406 through output port 408 could be transmitted to the computer 402 as indicated by the dashed line in FIG. 4. Therefore, in this exemplary embodiment, the computer monitor may be used to view the output video signal that includes the caption text. For example, the computer 402 may provide a first window on the computer monitor to run the captioning program, and a second window to enable a user to view the finished product of the captioning program, the video signal including caption text.

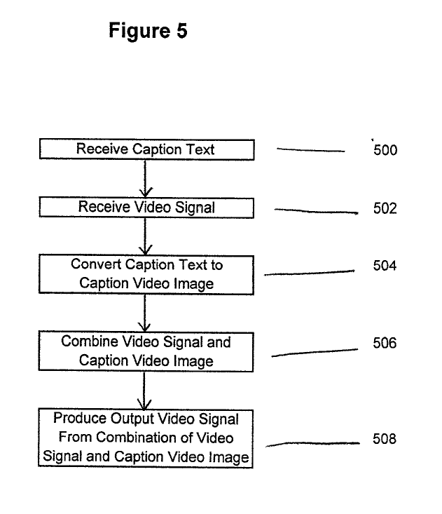

FIG. 5 illustrates a method of combining caption text and a video signal in accordance with an exemplary embodiment of the present invention. At step 500 caption text is received in a set top box from a computer. At step 502 a video signal is received in the set top box. The video signal is transmitted from a video source to the set top box. At step 504 the caption text received from the computer is converted into a video image in the set top box. The video signal and the video image are combined at step 506. At step 508 an output video signal is produced from the combined signal.

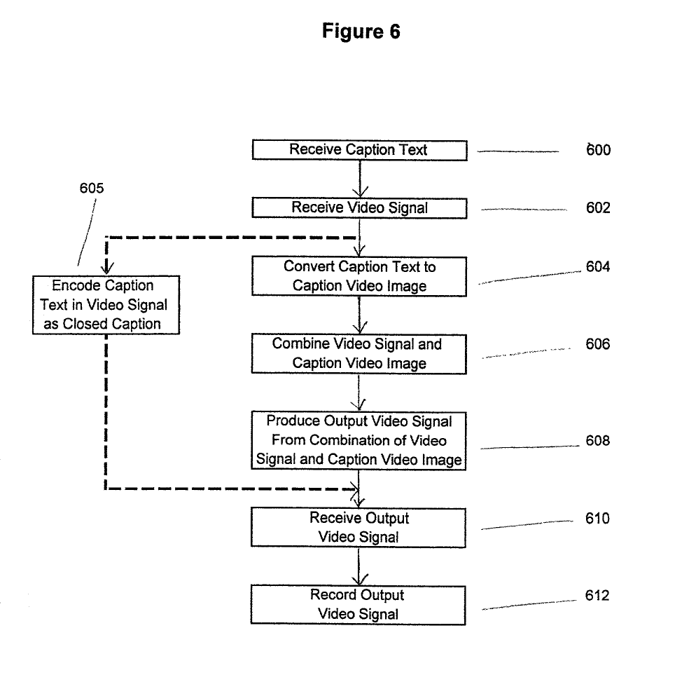

FIG. 6 illustrates a more detailed embodiment of the method of combining caption text and a video signal described by reference to FIG. 5, and includes additional exemplary steps. At step 600 caption text is received in a set top box from a computer. The set top box receives a video signal from a video source at step 602. The caption text received from the computer is converted into a video image at step 604. At step 606 the video signal and the video image are combined.

In another exemplary embodiment, steps 604, 606, and 608 are replaced by step 605. At step 605 the caption text is encoded in the video signal as a closed caption signal. The result is a combined video and closed caption signal.

After step 606 (or alternatively step 605), an output video signal is produced from the set top box using the combined signal at step 608. At step 610 the output video signal is received in a video recording device. The output video signal is then recorded onto a video storage medium in the video recording device at step 612.

Because the present invention uses a computer to store and edit caption text, an unlimited amount of caption text can be processed. This is advantageous as compared to video captioning systems that utilize a video signal processing device (e.g., a camcorder) to insert and edit caption text. Further, the computer can be used to implement enhanced text features. For example, the captioning system can be utilized to provide a particular style of caption text, a particular font size, or a particular text color.

Another advantage of the present invention is that existing hardware typically found in a set top box is used. The other items used in the system, such as a computer and a video cassette recorder, are already owned by many consumers. Therefore, no new hardware cost is incurred with the implementation of the system.

In the exemplary embodiments of the present invention described above, each line of caption text is shown on the displayed video signal for an amount of time sufficient so that the caption text may be read by the user. For example, each line of caption text may be viewed for a default period of time between three and five seconds. Alternatively, each line of caption text may be assigned an independent viewing time. Alternatively, the caption text may scroll across the displayed video image at a predefined speed that allows the caption text to be read.

In a further alternative embodiment, a file format may be established in the computer that the digital television set top box can interpret. For example, the syntax of the file format might be <TEXT_STRING>, <ROW>, <COLUMN>, <SIZE>, <STYLE>, <FCOLOR>, <BCOLOR>, <TIME>. For example, the <TEXT_STRING> represents the actual text of the line of caption text in the file. The <ROW> and <COLUMN> represent the location on the screen for displaying the caption text. The <SIZE> represents the font size of the caption text, and the <STYLE> represents the font style of the caption text (e.g., normal, bold, italics, etc). The <FCOLOR> represents the color of the font, and the <BCOLOR> represents the color of the background of the caption text. The <TIME> represents the time for a given line of caption text to be displayed over the video image on the display. Alternatively, a <SCROLLSPEED> variable may be defined that indicates the speed that a given line of caption text is to be scrolled across the video display.

An example of a caption text signal using this file format might be “IT WAS SUNNY”, 400, 20, ‘M’, ‘R’, “BLACK”, “WHITE”, 5. As such, the <TEXT STRING> reads “IT WAS SUNNY.” The <ROW> is row 400, and the <COLUMN> is column 20. The <SIZE> of the caption text is medium, and the <STYLE> is regular. The font color is “BLACK”, and the background of the caption text signal is “WHITE.” The time defined for displaying the caption text over the displayed video image is 5 seconds. Of course, this is just an example syntax, and alternative formats such as using numeric codes to signify the colors and text attributes is available.

Further, the captioning program may automatically generate codes from a word processing formatted file. For example, text in a word processing program may have particular attributes, such as a given color, typeface, font size, style, etc. In an embodiment of the present invention, the captioning program can read each line or word of caption text and determine the attributes of the text. The captioning program would then generate the appropriate code for each word or line of text corresponding to the respective attribute.

The microprocessor of the set top box is able to interpret the syntax of the file format and instruct the display processor of the set top box to display the proper text with associated attributes on the screen.

Although the present invention has been described in terms of hardware and software, it is contemplated that the invention could be implemented entirely in software on a computer readable carrier such as a magnetic or optical storage medium, or an audio frequency carrier or a radio frequency carrier.

Although illustrated and described above with reference to certain specific embodiments, the present invention in nevertheless not intended to be limited to the detail shown. Rather, various modifications may be made in the details within the scope and range of equivalence of the claims and without departing from the invention.

What is claimed:

1. A set top box comprising:
a first port for receiving a data signal that represents caption text;
a second port for receiving a video signal; and
a video processor responsive to the data signal for generating a further signal that represents the caption text and for combining the further signal with the video signal to provide an output video signal.

2. The set top box of claim 1 wherein the video processor includes an on-screen display for converting the caption text into a video image, and the video processor combines the video image and the video signal to form the output video signal.

3. The set top box of claim 1 wherein the video processor includes a closed caption encoder for encoding the video signal with the caption text to form the output video signal.

4. The set top box of claim 1 additionally comprising:
a computer readable carrier that includes computer readable software for use with a computer, wherein the computer readable software causes the computer to transmit the caption text to the first port of the set top box.

5. A method of combining caption text and a video signal comprising:
receiving caption text in a first port of a set top box;
receiving a video signal in a second port of the set top box;
combining the caption text and the video signal into an output video signal.

6. The method of claim 5 further comprising the step of:
converting the caption text into a video image.

7. The method of claim 5 wherein the step of combining includes encoding the video signal with the caption text as closed caption data.

8. The method of claim 5 further comprising the steps of:
receiving, in a video recording device, said output video signal; and
recording said output video signal onto a video storage medium.

9. A video captioning system comprising:
a computer including caption text;
a set top box including,
a first port for receiving a data signal from the computer that represents the caption text;
a second port for receiving a video signal from a video source; and
a video processor responsive to the data signal for generating a further signal that represents the caption text and for combining the further signal with the video signal to provide an output video signal.

10. The video captioning system of claim 9 wherein the computer is responsive to a command from a user to cause the computer to transmit the data signal that represents the caption text to the first port of the set top box.

11. The video captioning system of claim 9 wherein the computer is responsive to a predetermined keystroke to transmit the data signal that represents the caption text to the first port of the set top box.

12. The video captioning system of claim 9 wherein the data signal includes caption text information related to at least one of size, color, style, and location of the caption text, and the video processor uses the caption text information in the creation of the output signal.

13. A method of inserting caption text into a video signal comprising:
receiving, in a computer, a command to transmit a data signal that represents caption text stored in the computer;
receiving the data signal in a first port of a set top box;
receiving the video signal in a second port of the set top box;
combining the data signal and the video signal to provide an output video signal.

14. The method of claim 13 further comprising the step of:
programming a video processor in the set top box to convert the data signal to a video image and to combine the video image and the video signal into the output video image.

15. A computer readable carrier including computer program instructions which cause a computer to implement a method of inserting caption text into a video signal, the method comprising the steps of:
receiving, in a computer, a command to transmit a data signal that represents caption text stored in the computer;
receiving the data signal in a first port of a set top box;
receiving the video signal in a second port of the set top box;
combining the data signal and the video signal to produce an output video signal.
